(19) United States
(12) Patent Application Publication
(10) Pub. No.: US 2017/0008380 A1
(43) Pub. Date: Jan. 12, 2017

(54) FOLDABLE ADJUSTABLE SUN SHADE FOR VEHICLE SIDE WINDOW

(71) Applicant: Michael Wexler, Hadera (IL)

(72) Inventor: Michael Wexler, Hadera (IL)

(21) Appl. No.: 14/797,133

(22) Filed: Jul. 12, 2015

(51) Int. Cl. B60J 3/00; E06B 9/24

(52) U.S. Cl. CPC B60J 3/005; E06B 9/24; E06B 2009/2482

(57) ABSTRACT

A vehicle side window shade for mounting on the side window to block the sun and heat from entering the vehicle through the side window. It comprises a foldable, opaque cloth, with a plurality of thin, rigid yet flexible tabs attached to at least one of its edges. Installing the sunshade on a car's side window is done by wedging the tabs vertically into the upper edge of the window's frame, such that the top of each tab is pressed between the window's glass and the flexible rubber seal which lines the window's frame in the door.

The novelty of the invention lies in the combination of a foldable cloth and rigid yet flexible tabs, forming an effective and convenient vehicle side window shade.

### CROSS REFERENCE TO RELATED APPLICATIONS

The present invention claims the benefit of Provisional Patent Application Ser. No. 62,023,988 filed Jul. 14 2014.

### BACKGROUND OF THE INVENTION

Field of Invention

The present invention relates to the field of window sun shades for automobiles. Specifically, the invention relates to a foldable side-window sun shade detachably mounted on the interior of the vehicle.

Description of Prior Art

Many types of shades for vehicle side windows are commercially available. For example, there is one type of shade which is a fabric curtain mounted on a rail which is permanently fixed to the interior of the car. Also, there exist a sun shade which adheres to a side window of a car by means of suction cups, thus it must be removed before lowering the window. Another type of shade is affixed to the side window by means of thin hooks which are placed over the upper edge of the window, thus the window must be lowered in order to mount or remove the shade.

U.S. Pat. No. 20070074827 shows a window shade which is made from a single flexible sheet, where installation of the shade is performed by wedging an edge of the sheet between the side window and the frame of the window. This design is not convenient when substantial area of the window needs to be covered.

U.S. Pat. No. 20110042995 shows a shade device which extends upward from the bottom edge of a side window, where installation of the shade is performed by wedging the bottom edge of the shade into the gap between the window and the lower edge of the window's frame. This design is not convenient when substantial area of the window needs to be covered.

Thus, there is a need in the art for providing a vehicle side window shade which provides substantial protection from the sun, which is easy to mount, easy to remove, easy to adjust, easy to fold and store when not in use, and is reasonably low cost.

### BRIEF SUMMARY OF THE INVENTION

The present invention is a vehicle side window shade for mounting on the side window.

The invention comprises a foldable, opaque cloth, with a plurality of thin, rigid yet flexible tabs attached to at least one of its edges.

The sunshade is secured to a vehicle's side window by wedging the tabs vertically into the upper edge of the window's frame, such that the top of each tab is pressed between the window's glass and the flexible rubber seal which lines the window's frame.

The object of the invention is to provide a novel vehicle side window shade, which provides substantial protection from the sun, which is easy to mount, is easy to remove, is easy to fold and store when not in use, with easily adjustable width and horizontal position, which requires no modification to the vehicle, and is reasonably low cost.

### BRIEF DESCRIPTION OF THE DRAWINGS

FIG. 1 is a front elevation view of the preferred embodiment of the invention: a foldable, opaque cloth 1, with three flat tabs 2 attached to its top edge.

FIG. 2 is an exploded view of an embodiment of the invention in which T-shaped tabs 3 are sandwiched between two sheets of shading material.

FIG. 3 is a perspective view of a tab design which is rectangular and flat.

FIG. 4 is a perspective view of a tab design which is rectangular and curved.

FIG. 5 is a perspective view of a tab design which is rectangular and curved.

FIG. 6 is a perspective view of a tab design which is T-shaped.

### DETAILED DESCRIPTION OF THE INVENTION

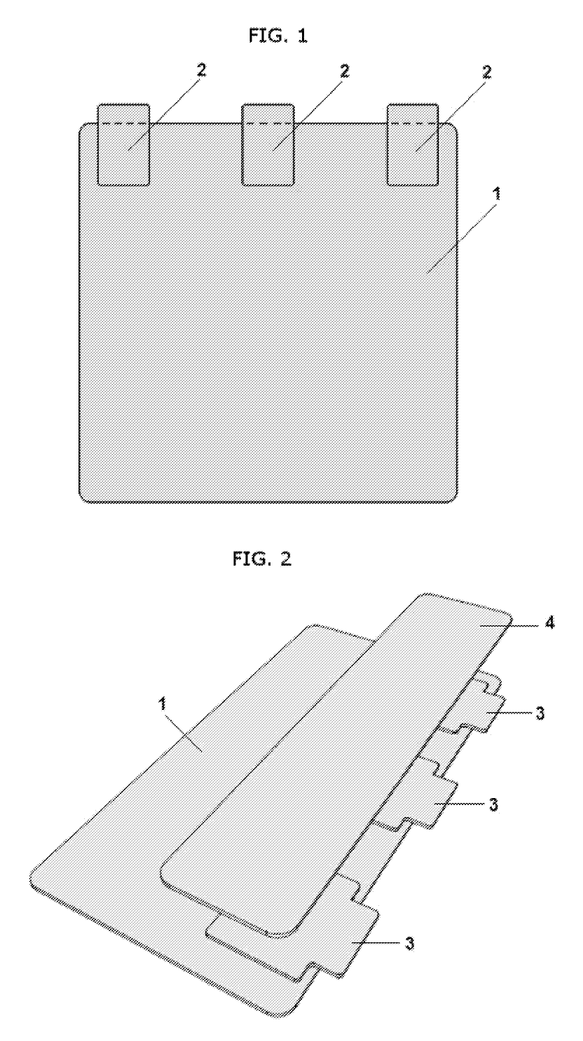

The preferred embodiment of the invention is shown on FIG. 1: a foldable, opaque cloth 1, in a form to essentially cover most of the surface area of a vehicle side window, with three tabs 2 attached to its top edge, such that each tab 2 protrudes beyond the perimeter of the cloth 1.

Installation of the sunshade on a vehicle's side window is performed from the inside of the vehicle, by first closing the window, and then wedging the tabs 2 vertically into the upper edge of the window's frame, such that each tab 2 is pressed between the window's glass and the flexible rubber seal which lines the window's frame in the door. Thus the cloth 1 is hanging down from the tabs 2, giving the desired effect as a sunshade.

Alternatively, installation of the sunshade can be performed regardless of the window being closed or opened, by wedging the tabs 2 vertically into the crevice between the upper edge of the door and the rubber seal which encircles the opening which is used for entering and exiting the car.

Removal of the sunshade is accomplished by pulling down on the cloth 1.

Once removed, the cloth 1 can be folded into a compact size for storage.

Adaptation to variations in side window widths is accomplished by wedging the tabs 2 either farther or closer to each other.

Adjustment of the window area covered by the present invention is accomplished by wedging the tabs 2 either farther or closer to each other.

The tabs may have different forms. for example: a rectangular tab 2, similar in dimensions and rigidity to a standard credit card (85.6×54×0.76 mm) is well suited to serve as the tab of the present invention.

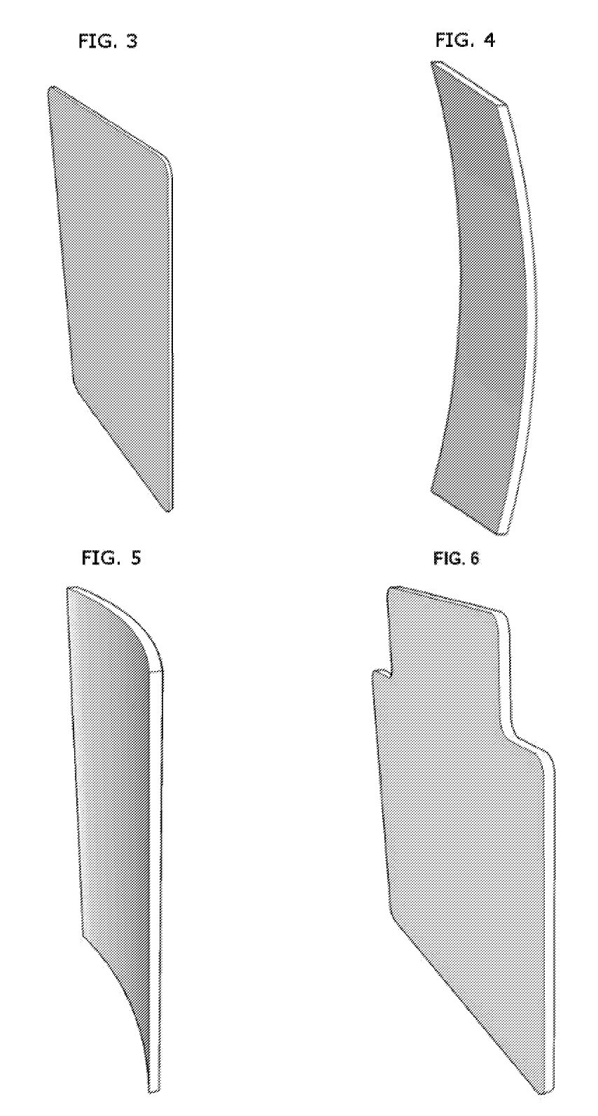

The curved tabs shown in FIG. 4 and FIG. 5 provide a stronger grip compared with the flat tab of FIG. 3, and are less likely to fall spontaneously once installed. The hump of the curved tabs created by the curvature is about 5 mm in height for the tab shown in FIG. 4, and about 2 mm for the tab shown in FIG. 5.

Installation of the sunshade equipped with the curved tabs shown in FIG. 4 and FIG. 5 is executed with the hump of the tab pointing away from the window's glass. Installation is performed by flattening each tab by pressing it against the closed window, and then moving each tab vertically upward while still being flattened against the window until wedged between the window's glass and the flexible rubber seal which lines the window's frame in the door.

Attaching the tabs to the cloth 1 may be accomplished in many different ways, for example: by means of gluing, stitching, stapling, riveting, or any combination thereof.

The T-shaped tab shown in FIG. 6 is designed to facilitate affixing it to the cloth 1 by way of stitching, as shown in FIG. 2, in which the T-shaped tabs are sandwiched between two layers of cloth: cloth 1 and cloth 4, such that only the majority of the narrow part of the T-shaped tabs protrudes beyond the edge of the cloths. The tabs are affixed to the cloths by stitches which are made around the perimeter of each tab, such that the thread passes through the two cloths only. This effectively creates pockets in the cloths, with each pocket housing a single T-shaped tab, with most of the narrow part of the tab protruding out of the pocket.

Instead of using two separate cloths, a single cloth may be used, folded upon itself.

The material used for the construction of the tabs should be rigid yet flexible, and it should not warp at the high temperatures which may be present inside a vehicle on a sunny day, which may reach as high as 70° C.

Numerous types of plastics and plastic compounds are suitable for construction of the tabs, for example: Polycarbonate, ABS, PVC, PP and PET, preferably with additives like Glass Fiber, to maintain rigidity at said temperatures.

The material used for the construction of the cloth 1 should provide adequate protection from the sun's radiation, and it should be thin and foldable for easy storage when not in use.

Various materials and fabrics are suitable for construction of the cloth 1, for example: Polyester, Lycra, Nylon, Cotton and Linen fabrics.

Printed fabrics may be used for their decorative effect and for advertising.

1. A shade device for a vehicle side window, comprising:
a. a foldable, opaque cloth, adapted to cover an area of the window; and
b. a plurality of rigid yet flexible tabs, each of said tabs having a thickness in a range of 0.2 mm to 1.4 mm and total surface area in a range of 3 square centimeters to 400 square centimeters, said tabs adapted to be detachably held in place by compressive force when wedged in the crevice between the surface of the window and the upper edge of the window's frame,
where at least two of said tabs are attached to said cloth adjacent to at least one edge of said cloth, such that at least one square centimeter of each of said tabs lies outside the perimeter of said cloth, said tabs adapted to support said cloth hanging down from said tabs in a shading position essentially parallel to the window on the inside of the vehicle when said tabs are wedged in the crevice between the surface of the window and the upper edge of the window's frame.

2. The shade of claim 1 wherein the total surface area of each of the two faces of said cloth is in a range of 400 square centimeters to 4000 square centimeters.

3. The shade of claim 1 wherein the cloth shape is tailored to fit exactly a specific window of a specific vehicle model.

4. The shade of claim 1 wherein at least one of said tabs has a curvature such that the curvature must be temporarily reduced in order to wedge the tab into the crevice between the surface of a vehicle's window and the window's frame.

5. The shade of claim 1 wherein the method of affixing said tabs to said cloth is selected from the group consisting of gluing, stitching, riveting, and stapling.

6. The shade of claim 1 wherein said cloth consists essentially of fabric selected from the group consisting of Polyester, Nylon, Cotton, and Lycra.

7. The shade of claim 1 wherein said tabs consists essentially of a plastic selected from the group consisting of ABS (acrylonitrile butadiene styrene), PVC (polyvinyl chloride), PC (polycarbonate), PP (polypropylene), and PET (polyethylene terephthalate).
